(19) United States
(12) Patent Application Publication
(10) Pub. No.: US 2026/0066545 A1
(43) Pub. Date: Mar. 5, 2026

(54) ELECTRONIC DEVICE COMPRISING ANTENNA STRUCTURE

(71) Applicant: Samsung Electronics Co., Ltd., Suwon-si (KR)

(72) Inventors: Sunghoon JUNG, Suwon-si (KR); Soyeon Kang, Suwon-si (KR); Dongho Kim, Suwon-si (KR); Sangyun Lee, Suwon-si (KR); Seongho Cho, Suwon-si (KR); Isaac Jo, Suwon-si (KR)

(73) Assignee: SAMSUNG ELECTRONICS CO., LTD., Suwon-si (KR)

(21) Appl. No.: 19/327,663

(22) Filed: Sep. 12, 2025

Related U.S. Application Data
(63) Continuation of application No. PCT/KR2025/012551, filed on Aug. 19, 2025.

(30) Foreign Application Priority Data
Sep. 2, 2024 (KR) 10-2024-0118765
Sep. 26, 2024 (KR) 10-2024-0130562

(51) Int. Cl. H01Q 13/10; H01Q 1/52

(52) U.S. Cl. CPC H01Q 13/10; H01Q 1/526

(57) ABSTRACT

An electronic device includes: a housing including a front surface plate, a rear surface plate, and a side surface member between the front surface plate and the rear surface plate; a printed circuit board inside the housing and including a first wire; and an antenna structure between the printed circuit board and the rear surface plate, where the antenna structure includes a first slit at a position corresponding to a position of the first wire.

### CROSS-REFERENCE TO RELATED APPLICATION(S)

This application is a continuation of International Application No. PCT/KR2025/012551, filed on Aug. 19, 2025, in the Korean Intellectual Property Receiving Office, which is based on and claims priority to Korean Patent Application No. 10-2024-0 118765, filed on Sep. 2, 2024, and Korean Patent Application No. 10-2024-0130562, filed on Sep. 26, 2024, in the Korean Intellectual Property Office, the disclosures of which are incorporated by reference herein in their entireties.

### BACKGROUND

### 1. Field

The disclosure relates to an electronic device including an antenna structure.

### 2. Description of Related Art

The use of an electronic device such as a bar-type electronic device, a foldable electronic device, a rollable or sliding electronic device is increasing, and various functions are being provided to an electronic device.

The electronic device may transmit and receive various data with other electronic devices (e.g., hearing aids) via wireless communication.

The electronic device may include at least one antenna for performing wireless communication with another electronic device.

The information described above may be provided as background art to aid in understanding the disclosure. No claim or determination is made as to whether any of the above description is prior art in connection with the disclosure.

### SUMMARY

Aspects will be set forth in part in the description which follows and, in part, will be apparent from the description, or may be learned by practice of the presented embodiments.

An electronic device may include a printed circuit board (PCB) having various electronic components arranged thereon. For example, a printed circuit board may include at least one wire configured to supply power from a battery to various electronic components. For example, in a case where power from a battery is supplied to an electronic component through at least one wire arranged on a printed circuit board so that current flows, a magnetic field (e.g., H-field) may be produced according to the flow of the current.

A shielding member including at least one antenna may be disposed on the rear surface of the printed circuit board. For example, the shielding member may shield noises occurred from a printed circuit board. For example, the shielding element may reduce the magnetic fields (e.g., H-fields) produced from a printed circuit board from being radiated to the rear surface of the electronic device, and may cause the magnetic fields to be radiated to the front and side surfaces of the electronic device.

For example, in a case where the magnetic field produced from a printed circuit board is radiated to the front and side surfaces of an electronic device, test performance related to hearing aid compatibility (HAC) of the electronic device and another electronic device (e.g., a hearing aid) may be degraded.

For example, in a case where the magnetic field produced from a printed circuit board is radiated to the front and side surfaces of an electronic device, the communication performance of another electronic device (e.g., a hearing aid) paired with the electronic device may be degraded. For example, another electronic device may be a hearing aid that includes a telecoil.

Various embodiments of the disclosure may provide an electronic device that forms a slit in an antenna structure and allows a portion of the magnetic field produced from a printed circuit board to be radiated to the rear surface of the electronic device, thereby reducing the amount of radiation to the front and side surfaces of the electronic device.

The technical problems to be achieved in the disclosure are not limited to the technical problems mentioned above, and other technical problems not mentioned will be clearly understood by a person skilled in the art in the technical field to which the disclosure belongs from the description below.

According to an aspect of the disclosure, an electronic device may include: a housing including a front surface plate, a rear surface plate, and a side surface member between the front surface plate and the rear surface plate; a printed circuit board inside the housing, and including a first wire; and an antenna structure between the printed circuit board and the rear surface plate, where the antenna structure includes a first slit at a position corresponding to a position of the first wire.

The electronic device may further include a battery; and a wireless communication circuit, where the first wire is configured to electrically connect the battery and the wireless communication circuit.

The electronic device may further include: a first power management circuit, where the printed circuit board further includes a second wire configured to electrically connect the battery and the first power management circuit, and where the antenna structure further includes a second slit at a position corresponding to a position of the second wire.

The electronic device may further include: a second power management circuit, where the printed circuit board further includes a third wire configured to electrically connect the battery and the second power management circuit, and where the antenna structure further includes a third slit at a position corresponding to a position of the third wire.

The antenna structure may further include a shielding member, where the first slit, the second slit, and the third slit are in the shielding member.

The first slit, the second slit and the third slit of the shielding member are configured to pass a magnetic field radiated by the printed circuit board toward the rear surface plate.

The antenna structure may further include at least one hole separated by at least one conductive pattern within the first slit.

The antenna structure may further include a connector configured to be electrically connected to the wireless communication circuit.

The antenna structure may further include a near field communication (NFC) antenna around the first slit and configured to be electrically connected to the connector.

The antenna structure may further include at least one of a wireless charging antenna and a magnetic secure transmission (MST) antenna configured to be electrically connected to the connector.

The first slit, the second slit, and the third slit may be integrally formed.

According to an aspect of the disclosure, an electronic device may include: a housing; a battery; a wireless communication circuit; at least one power management circuit; a printed circuit board inside the housing, the printed circuit board including a plurality of wires configured to electrically connect the battery to the wireless communication circuit and to the at least one power management circuit, respectively; and an antenna structure between the printed circuit board and the housing with respect to a thickness direction of the electronic device, where the antenna structure includes an opening corresponding to positions of the plurality of wires.

The antenna structure may further include a shielding member, where the opening is in the shielding member.

A first portion of the shielding member may include the opening, and a second portion of the shielding member may include a portion that does not include the opening, where the first portion of the shielding member is configured to pass a magnetic field radiated by the printed circuit board toward the rear surface plate, and the second portion of the shielding member is configured to prevent the magnetic field radiated by the printed circuit board from radiating toward the housing.

The antenna structure may further include a near field communication (NFC) antenna, where the NFC antenna is surrounding the opening.

The opening may include a plurality of slits respectively corresponding to the positions of the plurality of wires.

The plurality of slits may be integrally formed.

According to various embodiments of the disclosure, by allowing a portion of the magnetic field produced from a printed circuit board to be radiated to the rear surface of an electronic device through at least one slit formed in an antenna structure and reducing the amount of radiation to the front and side surfaces of the electronic device, test performance and communication performance related to compatibility of the electronic device and another electronic device (e.g., a hearing aid) can be improved.

In addition, various effects that are directly or indirectly identified through the disclosure may be provided.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1A is a block diagram of an electronic device in a network environment according to various embodiments of the disclosure;

FIG. 1B is a block diagram of a power management module and a battery according to various embodiments of the disclosure;

FIG. 2A is a perspective view of the front of an electronic device according to various embodiments of the disclosure;

FIG. 2B is a perspective view of the rear of an electronic device according to various embodiments of the disclosure;

FIG. 3 is an exploded perspective view of an electronic device according to one or more embodiments of the disclosure;

FIG. 4 is a diagram schematically showing an antenna structure included in the electronic device disclosed in FIG. 3 according to an embodiment of the disclosure;

FIG. 5 is a diagram schematically showing the configuration of a printed circuit board according to an embodiment of the disclosure;

FIG. 6 is a diagram schematically showing the radiation distribution of a magnetic field formed on a printed circuit board according to an embodiment of the disclosure;

FIG. 7 is a diagram schematically showing a state in which an antenna structure is arranged on a printed circuit board of an electronic device according to an embodiment of the disclosure;

FIG. 8 is a diagram schematically showing the radiation distribution of a magnetic field of an electronic device according to a comparative embodiment;

FIG. 9 is a diagram schematically showing the radiation distribution of a magnetic field of an electronic device according to an embodiment of the disclosure;

FIG. 10 is a diagram schematically showing a portion of an antenna structure including an opening according to one or more embodiments of the disclosure;

FIG. 11 is a diagram schematically showing a portion of an antenna structure including a first slit according to one or more embodiments of the disclosure; and

FIG. 12 is a diagram schematically showing an antenna structure including at least one conductive pattern according to one or more embodiments of the disclosure.

### DETAILED DESCRIPTION

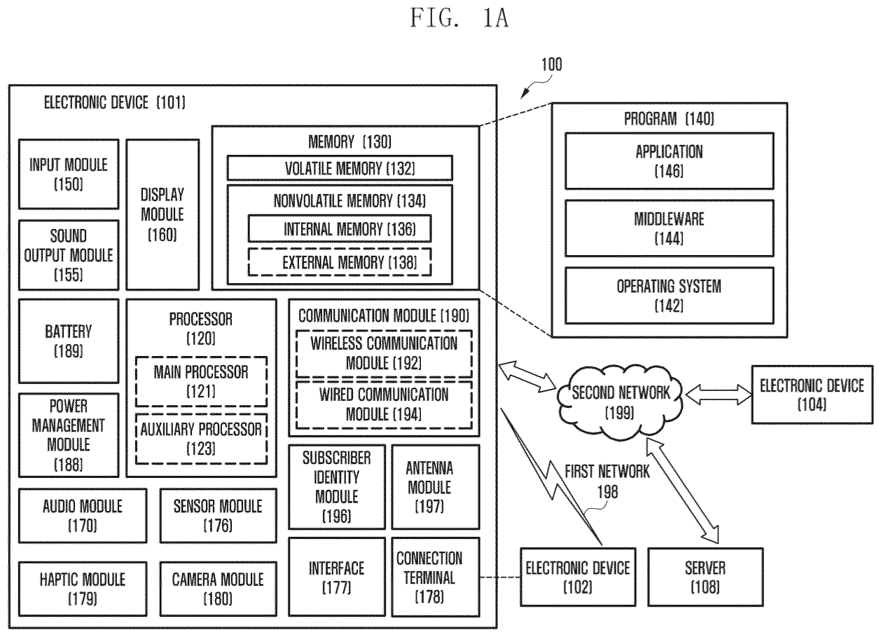

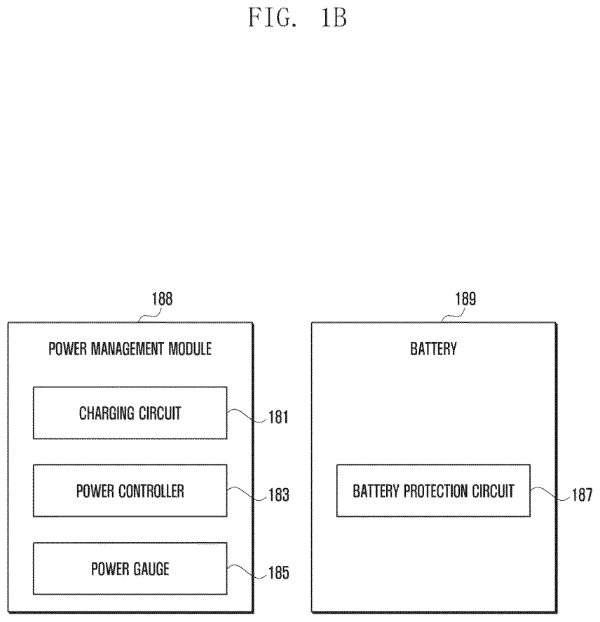

FIG. 1A is a block diagram illustrating an electronic device 101 in a network environment 100 according to various embodiments.

Referring to FIG. 1A, the electronic device 101 in the network environment 100 may communicate with an electronic device 102 via a first network 198 (e.g., a short-range wireless communication network), or at least one of an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In some embodiments, at least one of the components (e.g., the connecting terminal 178) may be omitted from the electronic device 101, or one or more other components may be added in the electronic device 101. In some embodiments, some of the components (e.g., the sensor module 176, the camera module 180, or the antenna module 197) may be implemented as a single component (e.g., the display module 160).

The processor 120 may execute, for example, software (e.g., a program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be adapted to consume less power than the main processor 121, or to be specific to a specified function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. An artificial intelligence model may be generated by machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by another component (e.g., the processor 120) of the electronic device 101, from the outside (e.g., a user) of the electronic device 101. The input module 150 may include, for example, a microphone, a mouse, a keyboard, a key (e.g., a button), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor adapted to detect a touch, or a pressure sensor adapted to measure the intensity of force incurred by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101

The sensor module 176 may detect an operational state (e.g., power or temperature) of the electronic device 101 or an environmental state (e.g., a state of a user) external to the electronic device 101, and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or a movement) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to one embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wired) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device via the first network 198 (e.g., a short-range communication network, such as Bluetooth™, wireless-fidelity (Wi-Fi) direct, or infrared data association (IrDA)) or the second network 199 (e.g., a long-range communication network, such as a legacy cellular network, a 5G network, a next-generation communication network, the Internet, or a computer network (e.g., LAN or wide area network (WAN)). These various types of communication modules may be implemented as a single component (e.g., a single chip), or may be implemented as multi components (e.g., multi chips) separate from each other. The wireless communication module 192 may identify and authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device) of the electronic device 101. According to an embodiment, the antenna module 197 may include an antenna including a radiating element composed of a conductive material or a conductive pattern formed in or on a substrate (e.g., a printed circuit board (PCB)). According to an embodiment, the antenna module 197 may include a plurality of antennas (e.g., array antennas). In such a case, at least one antenna appropriate for a communication scheme used in the communication network, such as the first network 198 or the second network 199, may be selected, for example, by the communication module 190 (e.g., the wireless communication module 192) from the plurality of antennas. The signal or the power may then be transmitted or received between the communication module 190 and the external electronic device via the selected at least one antenna. According to an embodiment, another component (e.g., a radio frequency integrated circuit (RFIC)) other than the radiating element may be additionally formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, commands or data may be transmitted or received between the electronic device 101 and the external electronic device 104 via the server 108 coupled with the second network 199. Each of the electronic devices 102 or 104 may be a device of a same type as, or a different type, from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

FIG. 1B is a block diagram illustrating the power management module 188 and the battery 189 according to various embodiments.

Referring to FIG. 1B, the power management module 188 may include charging circuitry 181, a power adjuster 183, or a power gauge 185. The charging circuitry 181 may charge the battery 189 by using power supplied from an external power source outside the electronic device 101. According to an embodiment, the charging circuitry 181 may select a charging scheme (e.g., normal charging or quick charging) based at least in part on a type of the external power source (e.g., a power outlet, a USB, or wireless charging), magnitude of power suppliable from the external power source (e.g., about 20 Watt or more), or an attribute of the battery 189, and may charge the battery 189 using the selected charging scheme. The external power source may be connected with the electronic device 101, for example, directly via the connecting terminal 178 or wirelessly via the antenna module 197.

The power adjuster 183 may generate a plurality of powers having different voltage levels or different current levels by adjusting a voltage level or a current level of the power supplied from the external power source or the battery 189. The power adjuster 183 may adjust the voltage level or the current level of the power supplied from the external power source or the battery 189 into a different voltage level or current level appropriate for each of some of the components included in the electronic device 101. According to an embodiment, the power adjuster 183 may be implemented in the form of a low drop out (LDO) regulator or a switching regulator. The power gauge 185 may measure use state information about the battery 189 (e.g., a capacity, a number of times of charging or discharging, a voltage, or a temperature of the battery 189).

The power management module 188 may determine, using, for example, the charging circuitry 181, the power adjuster 183, or the power gauge 185, charging state information (e.g., lifetime, over voltage, low voltage, over current, over charge, over discharge, overheat, short, or swelling) related to the charging of the battery 189 based at least in part on the measured use state information about the battery 189. The power management module 188 may determine whether the state of the battery 189 is normal or abnormal based at least in part on the determined charging state information. If the state of the battery 189 is determined to abnormal, the power management module 188 may adjust the charging of the battery 189 (e.g., reduce the charging current or voltage, or stop the charging). According to an embodiment, at least some of the functions of the power management module 188 may be performed by an external control device (e.g., the processor 120).

The battery 189, according to an embodiment, may include a battery protection circuit 187. The battery protection circuit 187 may perform one or more of various functions (e.g., a pre-cutoff function) to prevent a performance deterioration of, or a damage to, the battery 189. The battery protection circuit 187, additionally or alternatively, may be configured as at least part of a battery management system (BMS) capable of performing various functions including cell balancing, measurement of battery capacity, count of a number of charging or discharging, measurement of temperature, or measurement of voltage.

According to an embodiment, at least part of the charging state information or use state information regarding the battery 189 may be measured using a corresponding sensor (e.g., a temperature sensor) of the sensor module 176, the power gauge 185, or the power management module 188. According to an embodiment, the corresponding sensor (e.g., a temperature sensor) of the sensor module 176 may be included as part of the battery protection circuit 187, or may be disposed near the battery 189 as a separate device.

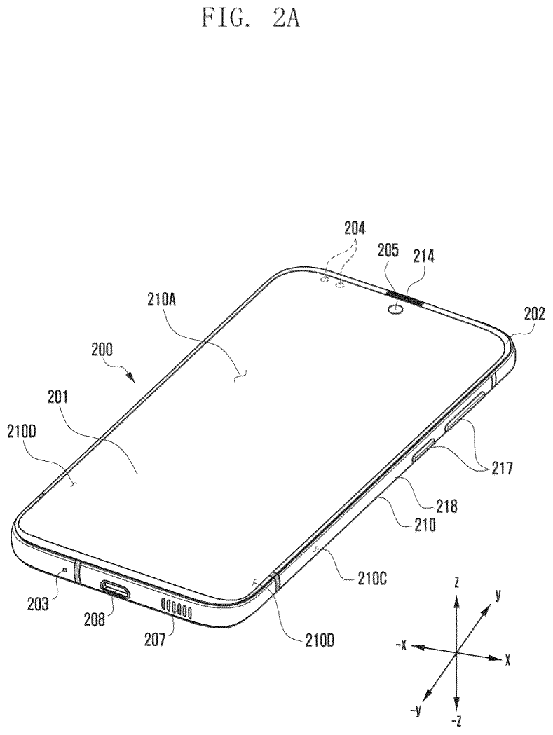

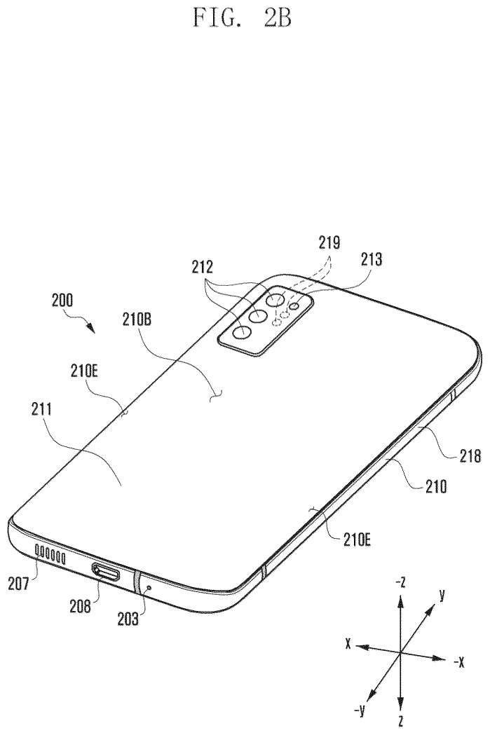

FIG. 2A is a front perspective view of an electronic device according to various embodiments of the disclosure. FIG. 2B is a rear perspective view of the electronic device in FIG. 2A according to various embodiments of the disclosure

Referring to FIG. 2A and FIG. 2B, an electronic device 200 according to an embodiment may include a housing 210 including a first surface (or front surface) 210A, a second surface (or rear surface) 210B, and a side surface 210C surrounding the space between the first surface 210A and the second surface 210B. In another embodiment, the housing may denote a structure that forms a part of the first surface 210A, the second surface 210B, and the side surface 210C illustrated in FIG. 2A and FIG. 2B. According to an embodiment, the first surface 210A may be formed by a front plate 202, at least a part of which is substantially transparent (for example, a glass plate including various coating layers, or a polymer plate). The second surface 210B may be formed by a rear plate 211 that is substantially opaque. The rear plate 211 may be made of coated or colored glass, ceramic, polymer, metal (for example, aluminum, stainless steel (STS), or magnesium), or a combination of at least two of the above-mentioned materials. The side surface 210C may be formed by a side bezel structure (or “side member”) 218 which is coupled to the front plate 202 and to the rear plate 211, and which includes metal and/or polymer. In some embodiments, the rear plate 211 and the side bezel structure 218 may be formed integrally and may include the same material (for example, a metal material such as aluminum).

In the illustrated embodiment, the front plate 202 may include two first areas 210D on both ends of the long edge of the front plate 202 such that the two first areas 210D bend from the first surface 210A toward the rear plate 211 and extend seamlessly. In the illustrated embodiment (see FIG. 2B), the rear plate 211 may include two second areas 210E on both ends of the long edge such that the two second areas 210E bend from the second surface 210B toward the front plate 202 and extend seamlessly. In some embodiments, the front plate 202 (or the rear plate 211) may include only one of the first areas 210D (or the second areas 210E). In another embodiment, a part of the first areas 210D or the second areas 210E may not be included. In the above embodiments, when seen from the side surface of the electronic device 200, the side bezel structure 218 may have a first thickness (or width) on a part of the side surface, which does not include the first areas 210D or the second areas 210E as described above, and may have a second thickness that is smaller than the first thickness on a part of the side surface, which includes the first areas 210D or the second areas 210E.

According to an embodiment, the electronic device 200 may include at least one of a display 201, audio module 203, 207 and 214, sensor modules 204 and 219, camera modules 205, 212, and 213, a key input device 217, an indicator, and connector hole 208. In some embodiments, at least one of the constituent elements (for example, the key input device 217 or the indicator) of the electronic device 200 may be omitted, or the electronic device 200 may additionally include another constituent element.

The display 201 may be exposed through a corresponding part of the front plate 202, for example. In some embodiments, at least a part of the display 201 may be exposed through the front plate 202 that forms the first areas 210D of the side surface 210C and the first surface 210A. In some embodiments, the display 201 may have a corner formed in substantially the same shape as that of the adjacent outer periphery of the front plate 202. In another embodiment, in order to increase the area of exposure of the display 201, the interval between the outer periphery of the display 201 and the outer periphery of the front plate 202 may be formed to be substantially identical.

The audio module may include a microphone hole 203 and a speaker holes 207, 214. The microphone hole 203 may include a plurality of microphones arranged therein such that the direction of a sound can be sensed in some embodiments. The speaker holes 207 and 214 may include an outer speaker hole 207 and a speech receiver hole 214. In some embodiments, the speaker holes 207 and 214 and the microphone hole 203 may be implemented as a single hole, or a speaker may be included (for example, a piezoelectric speaker) without the speaker holes 207 and 214.

The sensor modules 204 and 219 may generate an electric signal or a data value corresponding to the internal operating condition of the electronic device 200 or the external environment condition thereof. The sensor modules 204 and 219 may include, for example, a first sensor module 204 (for example, a proximity sensor) arranged on the first surface 210A of the housing 210, and/or a second sensor module (for example, a fingerprint sensor), and/or a third sensor module 219 (for example, an HRM sensor) arranged on the second surface 210B of the housing 210, and/or a fourth sensor module (for example, a fingerprint sensor). The fingerprint sensor may be arranged not only on the first surface 210A (for example, the display 201) of the housing 210, but also on the second surface 210B thereof. The electronic device 200 may further include a sensor module, for example, at least one of a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or a luminance sensor.

The camera modules 205, 212, and 213 may include a first camera device 205 arranged on the first surface 210A of the electronic device 200, a second camera device 212 arranged on the second surface 210B thereof, and/or a flash 213. The camera devices 205 and 212 may include a single lens or a plurality of lenses, an image sensor, and/or an image signal processor. The flash 213 may include, for example, a light-emitting diode or a xenon lamp. In some embodiments, two or more lenses (an infrared camera, a wide-angle lens, and a telephoto lens) and image sensors may be arranged on a single surface of the electronic device 200.

The key input device 217 may be arranged on the side surface 210C of the housing 210. In another embodiment, the electronic device 200 may not include a part of the above-mentioned key input device 217 or the entire key input device 217, and the key input device 217 may be implemented in another type, such as a soft key, on the display 201. In some embodiments, the key input device may include a sensor module arranged on the second surface 210B of the housing 210.

The indicator may be arranged on the first surface 210A of the housing 210, for example. The indicator may provide information regarding the condition of the electronic device 200 in a light type, for example. In another embodiment, the indicator may provide a light source that interworks with operation of the camera module 205, for example. The indicator may include, for example, an LED, an IR LED, and a xenon lamp.

The connector hole 208 may include a first connector hole 208 capable of containing a connector (for example, a USB connector) for transmitting/receiving power and/or data to/from an external electronic device, and/or a second connector hole (for example, an earphone jack) capable of containing a connector for transmitting/receiving an audio signal to/from the external electronic device.

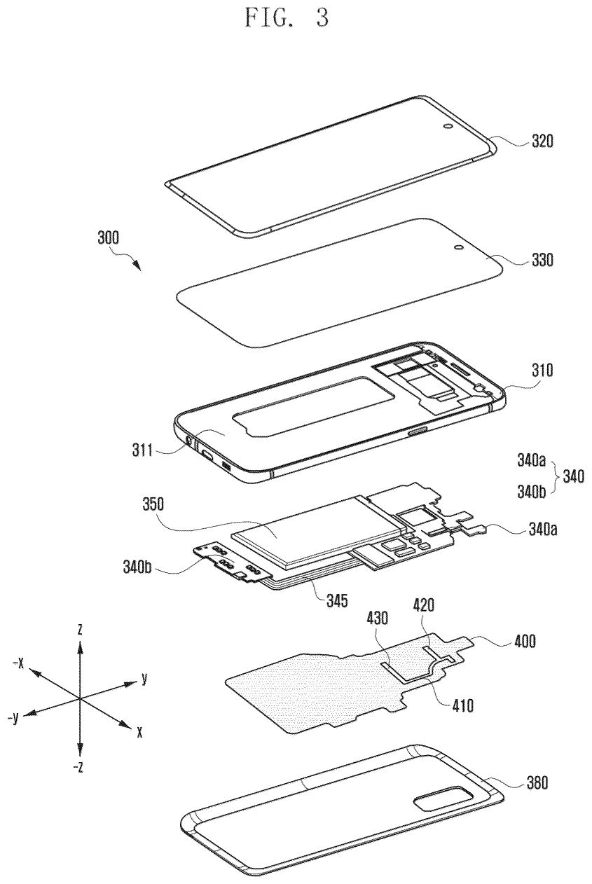

FIG. 3 is an exploded perspective view of an electronic device according to one or more embodiments of the disclosure.

Referring to FIG. 3, an electronic device 300 may include a side surface member 310 (e.g., a side bezel structure), a first support member 311 (e.g., a bracket), a front surface plate 320, a display 330, a printed circuit board 340, a battery 350, an antenna structure 400, and/or a rear surface plate 380.

According to an embodiment, the electronic device 300 may omit at least one of the components described above (e.g., the first support member 311) or may additionally include another component. For example, a second support member (e.g., a rear case) may be disposed between the printed circuit board 340 and the rear surface plate 380. At least one of the components of the electronic device 300 may be identical or similar to at least one of the components of the electronic device 101 of FIG. 1A, or the electronic device 200 of FIG. 2A and/or FIG. 2B, and any redundant description will be omitted below.

According to an embodiment, the side surface member 310 (e.g., the housing 210 of FIG. 2A) may form at least a portion of the exterior of the electronic device 300. The side surface member 310 (e.g., the housing 210 of FIG. 2A) may surround a space between the front surface plate 320 and the rear surface plate 380. For example, the side surface member 310 may include the side surface 210C, the side surface member 218, or the housing 210 disclosed in FIGS. 2A and 2B.

According to an embodiment, the first support member 311 may be disposed inside the electronic device 300 and connected to the side surface member 310 (e.g., the side surface 218 or the housing 210 of FIGS. 2A and 2B), or may be formed integrally with the side surface member 310. The first support member 311 may be formed of, for example, a metallic material and/or a non-metallic (e.g., a polymer) material. The first support member 311 may have the display 330 coupled to one surface (e.g., in the z-axis direction) and the printed circuit board 340 coupled to the other surface (e.g., in the-z-axis direction).

According to an embodiment, the printed circuit board 340 may be disposed inside the side surface member 310 (e.g., the housing 210 of FIG. 2A). For example, the printed circuit board 340 may be disposed in the-z-axis direction of the first support member 311. The printed circuit board 340 may include a first PCB 340a and/or a second PCB 340b. For example, the first PCB 340a and the second PCB 340b may be spaced apart from each other and electrically connected using a connection member 345 (e.g., a coaxial cable and/or FPCB). For example, the printed circuit board 340 may include a structure in which multiple printed circuit boards (PCBs) are stacked. For example, the printed circuit board 340 may include an interposer structure. For example, the printed circuit board 340 may be implemented in the form of a flexible printed circuit board (FPCB) and/or a rigid printed circuit board (PCB). For example, the printed circuit board 340 may include at least one wire and/or at least one conductive path.

According to an embodiment, the processor 120, the memory 130, the interface 177, the wireless communication module 192 and/or the power management module 188 disclosed in FIG. 1 may be arranged on the printed circuit board 340.

According to an embodiment, the processor 120 may include one or more of a central processing unit, an application processor, a graphics processing unit, an image signal processor, a sensor hub processor, or a communication processor.

According to an embodiment, the memory 130 may include, for example, volatile memory or non-volatile memory.

According to an embodiment, the interface 177 may include a high definition multimedia interface (HDMI), a universal serial bus (USB) interface, an SD card interface, and/or an audio interface. For example, the interface 177 may electrically or physically connect the electronic device 300 to an external electronic device (e.g., the electronic devices 102 and 104 of FIG. 1A), and may include a USB connector, an SD card/MMC connector, or an audio connector.

According to an embodiment, the wireless communication module 192 may include a radio frequency integrated circuit (RFIC). For example, the wireless communication module 192 may provide a feed signal to the antenna structure 400. For example, the wireless communication module 192 may transmit a radio frequency signal to the antenna structure 400.

According to an embodiment, the power management module 188 may manage power of the electronic device 300. For example, the power management module 188 may include at least one power management integrated circuit (PMIC). For example, in case that the electronic device 300 is powered ON, the power management module 188 may supply power from the battery 189 to other components (e.g., the processor 120, the memory 130, the wireless communication module 192). For example, the power management module 188 may receive commands from the processor 120 and manage power supplied to other components in response to the received commands. The power management module 188 (e.g., a PMIC) may support wired and/or wireless charging methods. For example, the wireless charging method may include at least one of a magnetic resonance method, a magnetic induction method, or an electromagnetic wave method, and may include additional circuitry for wireless charging (e.g., a coil loop, a resonant circuit, or a rectifier).

According to an embodiment, the battery 350 may supply power to at least one component of the electronic device 300. For example, the battery 350 may supply power to the wireless communication module 192 and/or the power management module 188. For example, the battery 350 may include a non-rechargeable primary battery, a rechargeable secondary battery, or a fuel cell. For example, at least a portion of the battery 350 may be disposed on substantially the same plane as the printed circuit board 340. For example, at least a portion of the battery 350 may be disposed between the first PCB 340a and the second PCB 340b. The battery 350 may be integrally disposed inside the electronic device 300. For example, the battery 350 may be disposed to be detachable from the electronic device 300.

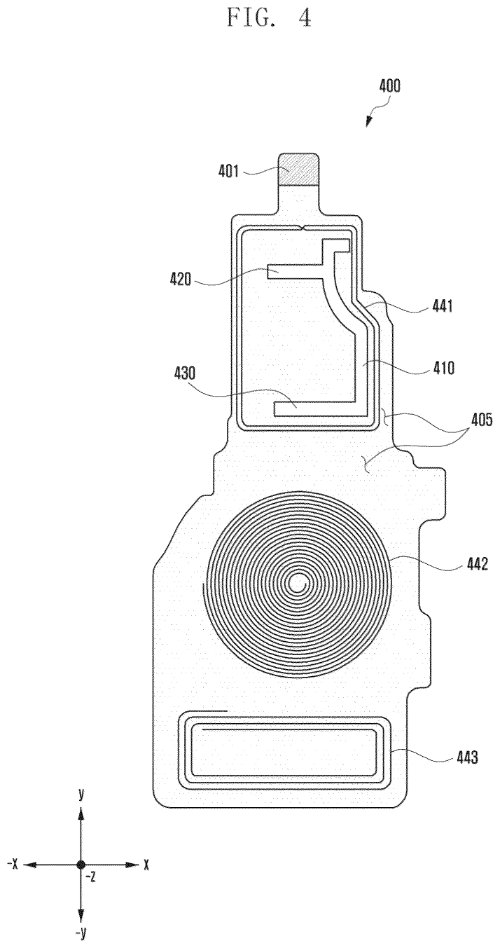

According to an embodiment, the antenna structure 400 may be disposed between the printed circuit board 340 and the rear surface plate 380. For example, the antenna structure 400 may be disposed between the battery 350 and the rear surface plate 380. For example, the antenna structure 400 may include at least one slit (e.g., a first slit 410, a second slit 420, and/or a third slit 430). For example, the antenna structure 400 may include a near field communication (NFC) antenna (e.g., an NFC antenna 441 of FIG. 4), a wireless charging antenna (e.g., a wireless charging antenna 442 of FIG. 4), and/or a magnetic secure transmission (MST) antenna (e.g., an MST antenna 443 of FIG. 4). For example, the antenna structure 400 may include a shielding member (e.g., a shielding member 405 of FIG. 4) (e.g., a conductive sheet). For example, the antenna structure 400 may perform short-range communication with an external electronic device (e.g., the electronic devices 102 and 104 of FIG. 1A) or wirelessly transmit and receive power required for charging. For example, the external electronic device (e.g., the electronic devices 102 and 104 of FIG. 1a) may include a hearing aid and/or wireless earphones. According to one or more embodiments, the antenna structure 400 may be formed by a portion or combination of the side surface member 310 and/or the first support member 311.

According to an embodiment, the electronic device 300 of FIG. 3 may substantially identically include the embodiments disclosed in the electronic device 101 of FIG. 1A and the electronic device 200 of FIG. 2A and/or FIG. 2B. For example, embodiments of the electronic device 300 disclosed in FIG. 3 may be configured to be substantially the same as the embodiments of the electronic device 200 disclosed in FIGS. 2A and 2B, while having only different reference numbers in the drawings.

According to one or more embodiments, the electronic device 300 of FIG. 3 may include embodiments which are at least partially similar to or different from those of the electronic device 101 of FIG. 1A and the electronic device 200 of FIG. 2A and/or FIG. 2B.

According to an embodiment, embodiments related to the electronic device 200 of FIGS. 2A and 2B and the electronic device 300 of FIG. 3 are described with respect to a bar-type electronic device, but one or more embodiments of the disclosure are not limited to the examples described above, and may be substantially equally applied to an electronic device such as a foldable electronic device, a rollable electronic device, a sliding electronic device, or a wearable electronic device.

According to one or more embodiments, in describing components of the electronic device 300 of FIG. 3, the same reference numerals have been used for the components substantially the same as those of the electronic device 101 of FIG. 1A and the electronic device 200 of FIGS. 2A and 2B, and the redundant description thereof may be omitted.

FIG. 4 is a diagram schematically showing an antenna structure included in the electronic device disclosed in FIG. 3 according to an embodiment of the disclosure.

Referring to FIGS. 3 and 4, the antenna structure 400 may be disposed between the printed circuit board 340 and the rear surface plate 380. For example, the antenna structure 400 may perform wireless communications with an external electronic device (e.g., the electronic devices 102 and 104 of FIG. 1A). For example, the antenna structure 400 may shield noise and/or a magnetic field produced from the printed circuit board 340.

According to an embodiment, the antenna structure 400 may include a connector 401, a shielding member 405, a first slit 410, a second slit 420, a third slit 430, an NFC antenna 441 (e.g., a first antenna), a wireless charging antenna 442 (e.g., a second antenna), and/or an MST antenna 443 (e.g., a third antenna).

According to an embodiment, the connector 401 may be electrically connected to the printed circuit board 340. The connector 401 may transmit a signal and/or current transmitted through the printed circuit board 340 to the antenna structure 400. For example, the connector 401 may be electrically connected to the wireless communication module 192 (e.g., a wireless communication circuit) and/or the power management module 188 arranged on the printed circuit board 340. For example, the connector 401 may be electrically connected to the NFC antenna 441 (e.g., a first antenna), the wireless charging antenna 442 (e.g., a second antenna), and the MST antenna 443 (e.g., a third antenna) via a conductive path (e.g., a wire).

In an embodiment, the shielding member 405 may shield noise produced from the printed circuit board 340. For example, the shielding member 405 may reduce the magnetic field (e.g., H-field) produced from the printed circuit board 340 from radiating toward the rear surface plate 380. For example, the shielding member 405 may reduce noise signals and/or magnetic fields produced from the printed circuit board 340 from radiating toward the rear surface (e.g., in the −z-axis direction) of the electronic device 300. For example, the shielding member 405 may include a conductive sheet or a conductive shielding member. For example, the shielding member 405 may include an at least partially formed dielectric substrate.

In an embodiment, the shielding member 405 may include at least one of the connector 401, the first slit 410, the second slit 420, the third slit 430, the NFC antenna 441 (e.g., the first antenna), the wireless charging antenna 442 (e.g., the second antenna), and the MST antenna 443 (e.g., the third antenna). For example, the connector 401, the NFC antenna 441 (e.g., the first antenna), the wireless charging antenna 442 (e.g., the second antenna), and the MST antenna 443 (e.g., the third antenna) may be disposed on the dielectric substrate at least partially formed on the shielding member 405.

According to an embodiment, the first slit 410 may be formed in the y-axis direction of the shielding member 405. For example, the first slit 410 may include an opening formed in the y-direction of the shielding member 405. For example, the first slit 410 may be formed in the shielding member 405 such that a magnetic field (e.g., H-field) produced from the printed circuit board 340 is radiated toward the rear surface plate 380. For example, a magnetic field produced from the printed circuit board 340 may be radiated toward the rear surface plate 380 through the first slit 410. For example, a magnetic field generated from the printed circuit board 340 may be radiated to the rear surface (e.g., in the-z-axis direction) of the electronic device 300 through the first slit 410. For example, in case that a magnetic field produced from the printed circuit board 340 is radiated through the first slit 410 to the rear surface plate 380 or the rear surface (e.g., in the −z-axis direction) of the electronic device 300, the amount of the magnetic field produced from the printed circuit board 340 and radiated toward the front surface (e.g., in the z-axis direction) and the side surfaces (e.g., in the x-axis direction and the −x-axis direction) of the electronic device 300 may decrease.

In an embodiment, in case that the amount of the magnetic field produced from the printed circuit board 340 and radiated toward the front surface (e.g., in the z-axis direction) and the side surfaces (e.g., in the x-axis direction, the −x-axis direction, the y-axis direction, and/or the-y-axis direction) of the electronic device 300 is reduced, test performance related to hearing aid compatibility (HAC) of the electronic device 300 and other electronic devices (e.g. hearing aids) may be improved. For example, in case that the amount of the magnetic field produced from the printed circuit board 340 and radiated toward the front surface (e.g., in the z-axis direction) and the side surfaces (e.g., in the x-axis direction, the −x-axis direction, the y-axis direction, and/or the −y-axis direction) of the electronic device 300 is reduced, the communication performance of the electronic device 300 and other electronic devices (e.g., hearing aids) paired with the electronic device 300 may be improved.

According to an embodiment, the second slit 420 may be formed in the shielding member 405 in the −x-axis direction perpendicular to the first slit 410. For example, the first slit 410 and the second slit 420 may be formed to be connected. For example, the first slit 410 and the second slit 420 may include an integrally formed opening. For example, the second slit 420 may be formed in the shielding member 405 to be closer to the connector 401 than the third slit 430. For example, the second slit 420 may be formed in the shielding member 405 to be closer to the connector in the y-axis direction than the third slit 430. The second slit 420 may be formed in the shielding member 405 so that a magnetic field (e.g., H-field) produced from the printed circuit board 340 is radiated toward the rear surface plate 380. For example, a magnetic field produced from the printed circuit board 340 may be radiated toward the rear surface plate 380 through the first slit 410 and the second slit 420. For example, a magnetic field produced from the printed circuit board 340 may be radiated to the rear surface (e.g., in the −z-axis direction) of the electronic device 300 through the first slit 410 and the second slit 420. For example, in case that a magnetic field produced from the printed circuit board 340 is radiated to the rear surface plate 380 or the rear surface (e.g., in the −z-axis direction) of the electronic device 300 through the first slit 410 and the second slit 420, the amount of the magnetic field produced from the printed circuit board 340 and radiated toward the front surface (e.g., in the z-axis direction) and the side surfaces (e.g., in the x-axis direction, the-x-axis direction, the y-axis direction, and/or the −y-axis direction) of the electronic device 300 may decrease.

According to an embodiment, the third slit 430 may be formed in the shielding member 405 in the −x-axis direction perpendicular to the first slit 410. For example, the first slit 410 and the third slit 430 may be formed to be connected. For example, the first slit 410 and the third slit 430 may include an integrally formed opening. For example, the third slit 430 may be formed in the shielding member 405 closer to the NFC antenna in the-y-axis direction than the second slit 420. The third slit 430 may be formed in the shielding member 405 so that a magnetic field (e.g., H-field) produced from the printed circuit board 340 is radiated toward the rear surface plate 380. For example, a magnetic field produced from the printed circuit board 340 may be radiated toward the rear surface plate 380 through at least one of the first slit 410, the second slit 420, and the third slit 430. For example, a magnetic field produced from the printed circuit board 340 may be radiated toward the rear surface (e.g., in the −z-axis direction) of the electronic device 300 through at least one of the first slit 410, the second slit 420, and the third slit 430. For example, if a magnetic field produced from the printed circuit board 340 is radiated to the rear surface plate 380 or the rear surface (e.g., in the −z-axis direction) of the electronic device 300 through at least one of the first slit 410, the second slit 420, and the third slit 430, the amount of the magnetic field produced from the printed circuit board 340 and radiated toward the front surface (e.g., in the z-axis direction) and the side surfaces (e.g., in the x-axis direction, the −x-axis direction, the y-axis direction, and/or the −y-axis direction) of the electronic device 300 may decrease.

According to one or more embodiments, the antenna structure 400 disclosed in FIG. 4 is described as including the first slit 410, the second slit 420, and the third slit 430, but only one of the first slit 410, the second slit 420, or the third slit 430 may be formed in the shielding member 405.

According to one or more embodiments, the first slit 410, the second slit 420, and/or the third slit 430 formed in the antenna structure 400 may be filled with a non-conductive material (e.g., a polymer). According to one or more embodiments, the first slit 410, the second slit 420, and/or the third slit 430 formed in the antenna structure 400 are described as being openings, but the disclosure is not limited thereto, and a non-conductive material (e.g., a non-conductive portion) may be formed in an area corresponding to the first slit 410, the second slit 420, and/or the third slit 430. For example, the shielding member 405 of the antenna structure 400 may include at least one non-conductive portion formed in the area corresponding to the first slit 410, the second slit 420, and/or the third slit 430.

According to one or more embodiments, the first slit 410, the second slit 420, and the third slit 430 formed in the antenna structure 400 disclosed in FIG. 4 are described as openings that are spatially connected to each other, but, as long as the amount of the magnetic field produced from the printed circuit board 340 and radiated to the front surface (e.g., in the z-axis direction) and the side surfaces (e.g., in the x-axis direction, the −x-axis direction, the y-axis direction, and/or the −y-axis direction) of the electronic device 300 can be reduced, the first slit 410, the second slit 420, or the third slit 430 may be formed in the shielding member 405 to be spaced apart from each other.

According to an embodiment, the NFC antenna 441 (e.g., the first antenna) may be disposed in the y-axis direction of the shielding member 405. The NFC antenna 441 may be formed to surround the first slit 410, the second slit 420, and/or the third slit 430. The NFC antenna 441 may perform short-range communication with an external electronic device (e.g., the electronic devices 102 and 104 of FIG. 1A). For example, the NFC antenna 441 may be disposed in the y-axis direction of the antenna structure 400. The NFC antenna 441 may be electrically connected to the connector 401 via a conductive path. For example, the NFC antenna 441 may be disposed on a dielectric substrate formed on the shielding member 405.

According to an embodiment, the wireless charging antenna 442 (e.g., the second antenna) may be disposed between the NFC antenna 441 and the MST antenna 443. The wireless charging antenna 442 may charge the electronic device 300 or wirelessly supply power to an external electronic device (e.g., the electronic devices 102 and 104 of FIG. 1A). The wireless charging antenna 442 may be electrically connected to the connector 401 via a conductive path. For example, the wireless charging antenna 442 may be disposed on a dielectric substrate formed on the shielding member 405.

According to an embodiment, the MST antenna 443 (e.g., the third antenna) may be disposed in the −y-axis direction of the shielding member 405. The MST antenna 443 may be used for electronic payment of the electronic device 300. The MST antenna 443 may be electrically connected to the connector 401 via a conductive path. For example, the MST antenna 443 may be disposed on a dielectric substrate formed on the shielding member 405.

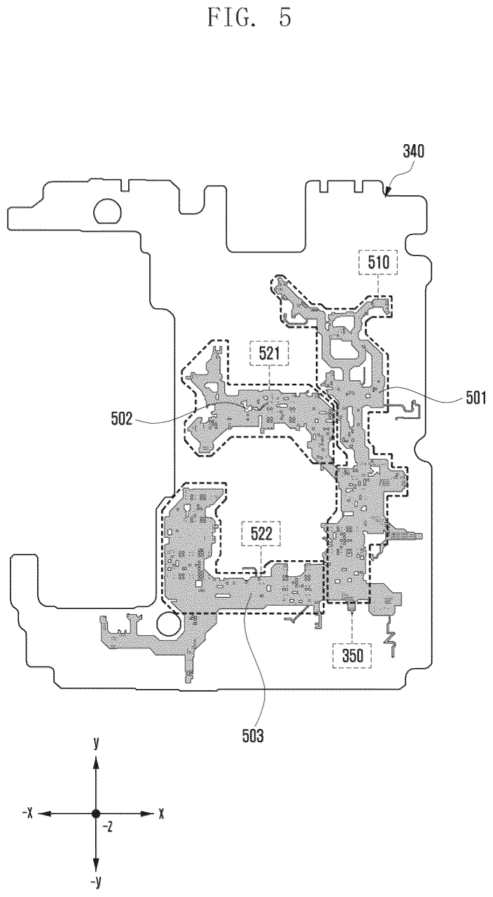

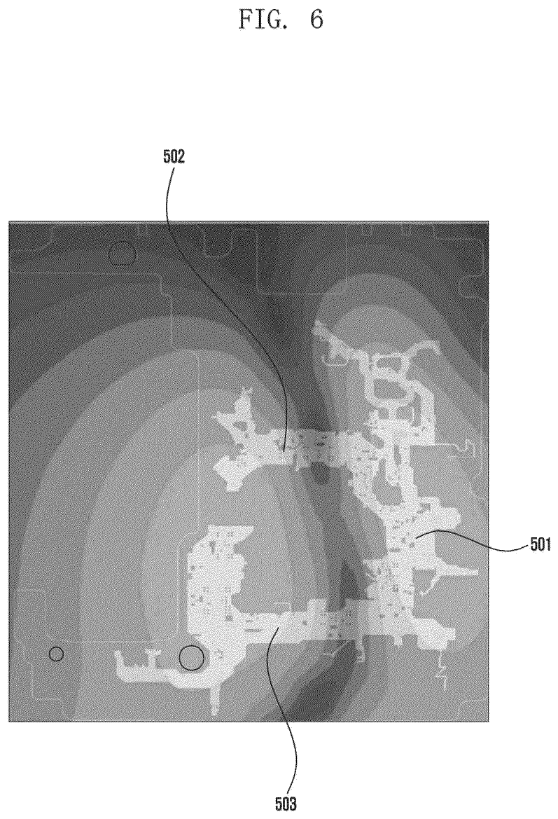

FIG. 5 is a diagram schematically showing the configuration of a printed circuit board according to an embodiment of the disclosure. FIG. 6 is a diagram schematically showing the radiation distribution of a magnetic field formed on a printed circuit board according to an embodiment of the disclosure.

Referring to FIG. 5 and FIG. 6, the printed circuit board 340 (e.g., the first PCB 340a) according to an embodiment of the disclosure may include a first wire 501, a second wire 502, and/or a third wire 503.

In an embodiment, the first wire 501 may electrically connect the battery 350 (e.g., the battery 189 of FIG. 1A) and a wireless communication circuit 510. For example, the first wire 501 may be formed in a path (e.g., a first path) that electrically connects the battery 350 and the wireless communication circuit 510 (e.g., an RFIC). For example, the first wire 501 may be a path that transmits power from the battery 350 to the wireless communication circuit 510 (e.g., RFIC). For example, in case that power from the battery 350 is transmitted to the wireless communication circuit 510 and current flows through the first wire 501, a magnetic field (e.g., H-field) may be produced around the first wire 501 as disclosed in FIG. 6.

According to one or more embodiments, the first wire 501 may include at least one of a conductive connection member, a wire, a plating layer, and an FPCB. For example, the wireless communication circuit 510 may transmit a feed signal and/or a radio frequency signal to the antenna structure 400. The wireless communication circuit 510 may include the wireless communication module 192 disclosed in FIG. 1, and may include embodiments which are substantially identical to the wireless communication module 192.

According to an embodiment, the second wire 502 may electrically connect the battery 350 and a first power management circuit 521 (e.g., a first PMIC). For example, the second wire 502 may be formed in a path (e.g., a second path) that electrically connects the battery 350 and the first power management circuit 521. For example, the second wire 502 may be a path that transmits power from the battery 350 to the first power management circuit 521. For example, power from the battery 350 may be transmitted to the first power management circuit 521 via a part of the first wire 501 and the second wire 502. For example, in case that power from the battery 350 is transmitted to the first power management circuit 521 and current flows through the second wire 502, a magnetic field may be produced around the second wire 502 as disclosed in FIG. 6.

According to one or more embodiments, the second wire 502 may include at least one of a conductive connection member, a wire, a plating layer, and an FPCB. For example, the first power management circuit 521 may include the power management module 188 disclosed in FIG. 1, and may include embodiments which are substantially identical to the power management module 188.

In an embodiment, the third wire 503 may electrically connect the battery 350 and a second power management circuit 522 (e.g., a second PMIC). For example, the third wire 503 may be disposed in a path (e.g., a third path) that electrically connects the battery 350 and the second power management circuit 522. For example, the third wire 503 may be a path that transmits power from the battery 350 to the second power management circuit 522. For example, power from the battery 350 may be transmitted to the second power management circuit 522 via a part of the first wire 501 and the third wire 503. For example, in case that the power of the battery 350 is transmitted to the second power management circuit 522 and current flows through the third wire 503, a magnetic field may be produced around the third wire 503 as disclosed in FIG. 6.

According to one or more embodiments, the third wire 503 may include at least one of a conductive connection member, a wire, a plating layer, and an FPCB. For example, the second power management circuit 522 may include the power management module 188 disclosed in FIG. 1, and may include embodiments which are substantially identical to the power management module 188.

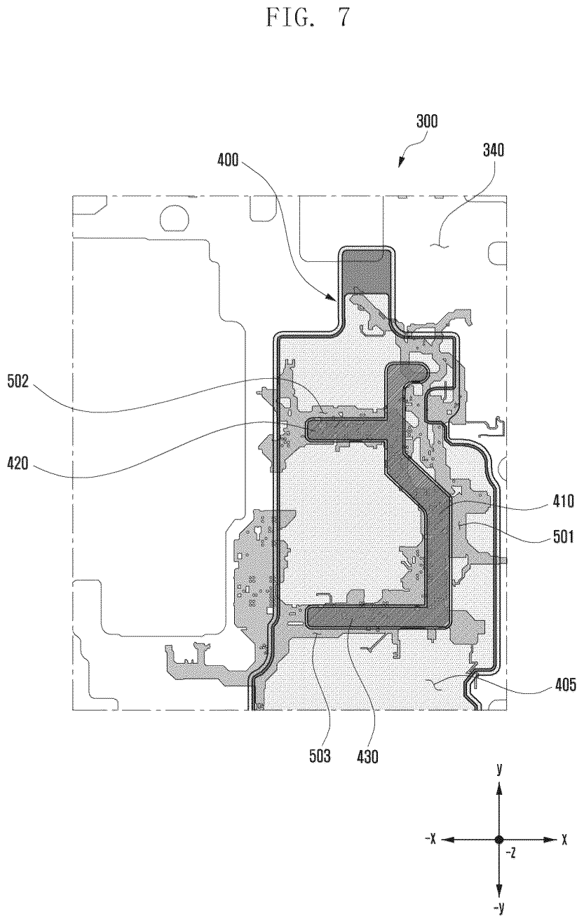

FIG. 7 is a diagram schematically showing a state in which an antenna structure is arranged on a printed circuit board of an electronic device according to an embodiment of the disclosure.

For example, FIG. 7 may be a drawing of a part of the antenna structure 400 viewed from the −z axis in the state in which the antenna structure 400 is disposed on the printed circuit board 340 of the electronic device 300 disclosed in FIG. 4.

According to an embodiment, the first slit 410 formed in the antenna structure 400 may be formed at a position corresponding to the first wire 501 of the printed circuit board 340. For example, the first slit 410 may be formed in the antenna structure 400 (e.g., the shielding member 405) to at least partially overlap the first wire 501 disposed on the printed circuit board 340. For example, referring to FIG. 5, the first wire 501 may be disposed in a path (e.g., the first path) that electrically connects the battery 350 and the wireless communication circuit 510. For example, high magnetic field radiation may be produced around the first wire 501 that electrically connects the battery 350 and the wireless communication circuit 510. For example, the magnetic field produced around the first wire 501 may be radiated to the rear surface (e.g., in the −z-axis direction) of the electronic device 300 through the first slit 410 formed at a position corresponding to the first wire 501. For example, in case that the magnetic field produced in the first wire 501 is radiated and/or emitted to the rear surface (e.g., in the −z-axis direction) of the electronic device 300 through the first slit 410, the amount of radiation to the front surface (e.g., in the z-axis direction) and the side surfaces (e.g., in the x-axis direction, the −x-axis direction, the y-axis direction, and/or the −y-axis direction) of the electronic device 300 may decrease.

According to an embodiment, the second slit 420 formed in the antenna structure 400 may be formed at a position corresponding to the second wire 502 of the printed circuit board 340. For example, the second slit 420 may be formed in the antenna structure 400 (e.g., the shielding member 405) to at least partially overlap the second wire 502 disposed on the printed circuit board 340. For example, referring to FIG. 5, the second wire 502 may be disposed in a path (e.g., the second path) that electrically connects the battery 350 and the first power management circuit 521. For example, high magnetic field radiation may be produced around the second wire 502 that electrically connects the battery 350 and the first power management circuit 521. For example, the magnetic field produced around the second wire 502 may be radiated to the rear surface (e.g., in the-z-axis direction) of the electronic device 300 through the second slit 420 formed at a position corresponding to the second wire 502. For example, in case that the magnetic field produced in the second wire 502 is radiated to the rear surface (e.g., in the −z-axis direction) of the electronic device 300 through the second slit 420, the amount of radiation to the front surface (e.g., in the z-axis direction) and the side surfaces (e.g., in the x-axis direction, the −x-axis direction, the y-axis direction, and/or the −y-axis direction) of the electronic device 300 may decrease.

According to an embodiment, the third slit 430 formed in the antenna structure 400 may be formed at a position corresponding to the third wire 503 of the printed circuit board 340. For example, the third slit 430 may be formed in the antenna structure 400 (e.g., the shielding member 405) to at least partially overlap the third wire 503 disposed on the printed circuit board 340. For example, referring to FIG. 5, the third wire 503 may be disposed in a path (e.g., the third path) that electrically connects the battery 350 and the second power management circuit 522. For example, high magnetic field radiation may be produced around the third wire 503 which electrically connects the battery 350 and the second power management circuit 522. For example, the magnetic field produced around the third wire 503 may be radiated to the rear surface (e.g., in the −z-axis direction) of the electronic device 300 through the third slit 430 formed at a position corresponding to the third wire 503. For example, in case that the magnetic field produced around the third wire 503 is radiated to the rear surface (e.g., in the −z-axis direction) of the electronic device 300 through the third slit 430, the amount of radiation to the front surface (e.g., in the z-axis direction) and the side surfaces (e.g., in the x-axis direction, the-x-axis direction, the y-axis direction, and/or the-y-axis direction) of the electronic device 300 may decrease.

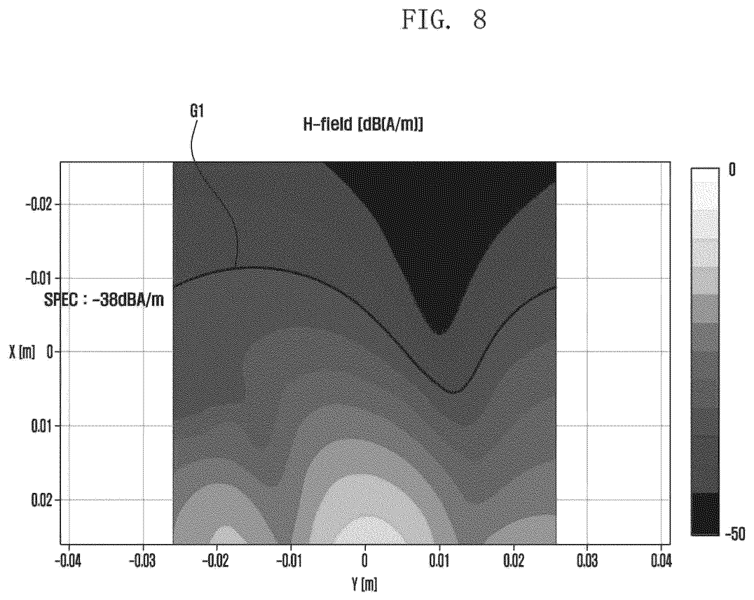

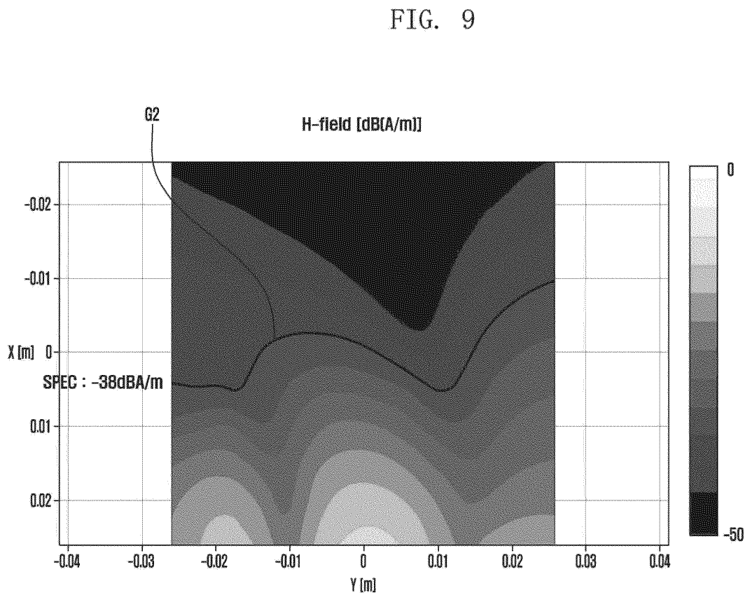

FIG. 8 is a diagram schematically showing the radiation distribution of a magnetic field of an electronic device according to a comparative embodiment. FIG. 9 is a diagram schematically showing the radiation distribution of a magnetic field of an electronic device according to an embodiment of the disclosure.

For example, an electronic device according to a comparative embodiment may be an embodiment in which a shielding member without a slit formed on the rear surface of a printed circuit board is disposed. FIG. 7 may be a diagram schematically showing the radiation distribution of the magnetic field produced from a printed circuit board and radiated to the front surface and side surfaces of an electronic device in case that a shielding member without a slit formed on the rear surface of the printed circuit board is placed.

For example, an electronic device 300 according to an embodiment of the disclosure may be an embodiment in which an antenna structure 400 (e.g., the shielding member 405) having at least one slit (e.g., the first slit 410, the second slit 420, and/or the third slit 430) formed on a rear surface (e.g., in the −z-axis direction) of a printed circuit board 340 is disposed. For example, FIG. 8 may be a diagram schematically showing the radiation distribution in which the magnetic field produced from the printed circuit board 340 is radiated to the front surface and side surfaces of the electronic device 300, in case that the antenna structure 400 (e.g., the shielding member 405) having at least one slit formed on the rear surface (e.g., in the −z-axis direction) of the printed circuit board 340 is disposed.

Referring to FIG. 8, in an electronic device according to a comparative embodiment, a shielding member in which no slit is formed is disposed on the rear surface of a printed circuit board, the magnetic field produced from the printed circuit board is not radiated to the rear surface of the electronic device, and thus, the radiation distribution of the magnetic field emitted from the front surface and side surfaces of the electronic device may be represented as a first graph G1.

Referring to FIG. 9, in the electronic device 300 according to an embodiment of the disclosure, the antenna structure 400 (e.g., the shielding member 405) having at least one slit (e.g., the first slit 410, the second slit 420, and/or the third slit 430) formed therein is disposed on the rear surface (e.g., in the −z-axis direction) of the printed circuit board 340, the magnetic field produced from the printed circuit board 340 is radiated to the rear surface (e.g., in the-z-axis direction) of the electronic device 300 through the at least one slit, and thus, the radiation distribution of the magnetic field emitted from the front surface (e.g., in the z-axis direction) and the side surfaces (e.g., in the x-axis direction, the −x-axis direction, the y-axis direction, and/or the −y-axis direction) of the electronic device 300 may be represented as a second graph G2.

Comparing the first graph G1 showing the radiation distribution for the front and side surfaces of the electronic device according to the comparative embodiment disclosed in FIG. 8 and the second graph G2 showing the radiation distribution for the front and side surfaces of the electronic device 300 according to the embodiment of the disclosure disclosed in FIG. 9, in the electronic device 300 according to an embodiment of the disclosure, the magnetic field produced from the printed circuit board 340 is radiated to the rear surface (e.g., in the −z-axis direction, the rear surface plate 380) of the electronic device 300 through at least one slit (e.g., the first slit 410, the second slit 420, and/or the third slit 430), and thus, it can be identified that the amount of magnetic field radiation emitted from the front surface (e.g., in the z-axis direction) and the side surfaces (e.g., in the x-axis direction, the −x-axis direction, the y-axis direction, and/or the −y-axis direction) of the electronic device 300 is lower than the amount of radiation of the electronic device according to the comparative embodiment.

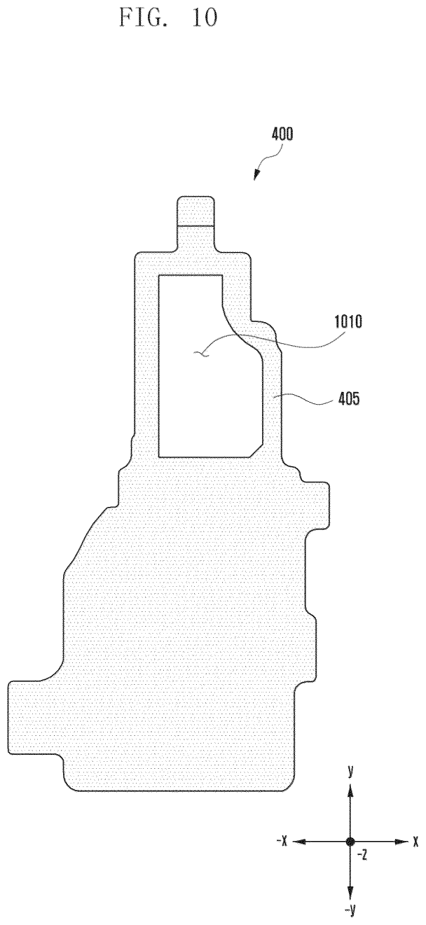

FIG. 10 is a diagram schematically showing a portion of an antenna structure including an opening according to one or more embodiments of the disclosure.

According to one or more embodiments, the antenna structure 400 may include an opening 1010 having a size and/or shape that corresponds to an expanded area of the printed circuit board including the first wire 501, the second wire 502 and the third wire 503, instead of, for example, the form of a plurality of connected slits such as the first slit 410, the second slit 420, and/or the third slit 430 disclosed in FIG. 4. For example, the opening 1010 may be formed in the shielding member 405 of the antenna structure 400. For example, the opening 1010 may be formed at a position and/or area corresponding to the first wire 501, the second wire 502, and the third wire 503 disclosed in FIG. 5. The opening 1010 may be formed in an area covering the first wire 501, the second wire 502, and the third wire 503 disclosed in FIG. 5. For example, the opening 1010 may be formed in the antenna structure 400 (e.g., the shielding member 405) to overlap the first wire 501, the second wire 502, and the third wire 503 arranged on the printed circuit board 340 of FIG. 5.

According to one or more embodiments, the magnetic field produced from the printed circuit board 340 may be radiated toward the rear surface (e.g., in the −z-axis direction) of the electronic device 300 through the opening 1010 formed in the antenna structure 400 (e.g., the shielding member 405). For example, in case that the magnetic field produced from the printed circuit board 340 is radiated to the rear surface (e.g., in the −z-axis direction) of the electronic device 300 through the opening 1010, the amount of magnetic field produced from the printed circuit board 340 and radiated toward the front surface (e.g., in the z-axis direction) and the side surfaces (e.g., in the x-axis direction, the −x-axis direction, the y-axis direction, and/or the −y-axis direction) of the electronic device 300 may decrease.

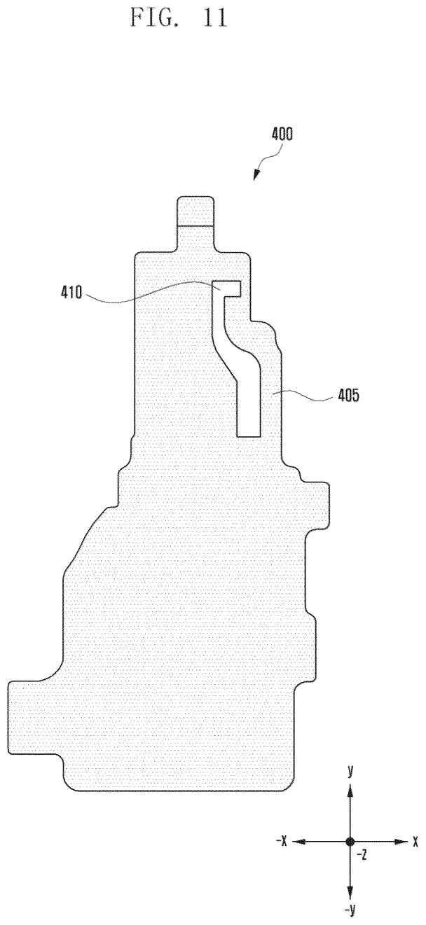

FIG. 11 is a diagram schematically showing a portion of an antenna structure including a first slit according to one or more embodiments of the disclosure.

According to one or more embodiments, the antenna structure 400 may include, for example, the first slit 410 disclosed in FIG. 4. For example, the first slit 410 may be formed in the shielding member 405 of the antenna structure 400. For example, the first slit 410 may be formed at a position and/or area corresponding to the first wire 501 disclosed in FIG. 5. The first slit 410 may be formed in an area covering the first wire 501 disclosed in FIG. 5. For example, the first slit 410 may be formed in the antenna structure 400 (e.g., the shielding member 405) to overlap the first wire 501 disposed on the printed circuit board 340 of FIG. 5.

According to one or more embodiments, the magnetic field produced from the first wire 501 of the printed circuit board 340 may be radiated toward the rear surface (e.g., in the-z-axis direction) of the electronic device 300 through the first slit 410 formed in the antenna structure 400 (e.g., the shielding member 405). For example, if the magnetic field produced from the first wire 501 of the printed circuit board 340 is radiated to the rear surface (e.g., in the −z-axis direction) of the electronic device 300 through the first slit 410, the amount of the magnetic field produced from the first wire 501 of the printed circuit board 340 and radiated toward the front surface (e.g., z-axis direction) and side surfaces (e.g., x-axis direction, −x-axis direction, y-axis direction, and/or −y-axis direction) of the electronic device 300 may decrease.

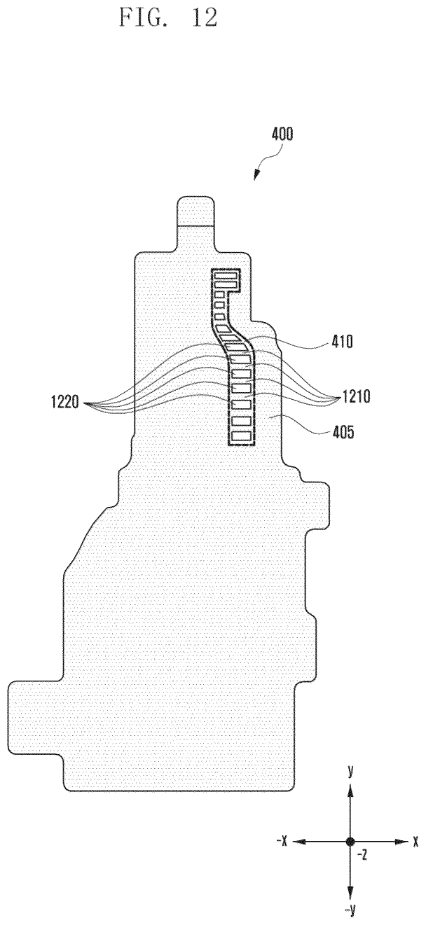

FIG. 12 is a diagram schematically showing an antenna structure including at least one conductive pattern according to one or more embodiments of the disclosure.

According to one or more embodiments, the antenna structure 400 may be formed to include at least one conductive pattern 1210 and at least one hole 1220, instead of being formed, for example, in the form of the first slit 410 disclosed in FIG. 4. For example, the first slit 410 disclosed in FIG. 4 may include at least one conductive pattern 1210. For example, the antenna structure 400 (e.g., the shielding member 405) may include at least one hole 1220 separated by the at least one conductive pattern 1210 disposed inside the first slit 410. For example, the first slit 410 may include the at least one hole 1220 formed by the at least one conductive pattern 1210. For example, the first slit 410 may be separated from the at least one hole 1220 by the at least one conductive pattern 1210 formed in the shielding member 405. For example, the at least one hole 1220 formed by the at least one conductive pattern 1210 may be formed at a position and/or area corresponding to the first wire 501 disclosed in FIG. 5. For example, the at least one hole 1220 may be formed in the antenna structure 400 (e.g., the shielding member 405) to at least partially overlap the first wire 501 disposed on the printed circuit board 340 of FIG. 5.

According to one or more embodiments, the magnetic field produced from the printed circuit board 340 may be radiated toward the rear surface (e.g., in the −z-axis direction) of the electronic device 300 through the at least one hole 1220 formed in the antenna structure 400 (e.g., the shielding member 405). For example, in case that the magnetic field produced from the printed circuit board 340 is radiated through the at least one hole 1220 toward the rear surface (e.g., in the −z-axis direction) of the electronic device 300, the amount of the magnetic field produced from the printed circuit board 340 and radiated to the front surface (e.g., in the z-axis direction) and side surfaces (e.g., in the x-axis direction, the −x-axis direction, the y-axis direction, and/or the −y-axis direction) of the electronic device 300 may decrease.

An electronic device (101, 200, 300) according to an embodiment of the disclosure may include a housing 210 including a front surface plate 320, a rear surface plate 380, and a side surface member 310 configured to surround a space between the front surface plate 320 and the rear surface plate 380. According to an embodiment, the electronic device 300 may include a printed circuit board 340 disposed inside the housing 210, a first wire 501 formed on the printed circuit board 340, and an antenna structure 400 disposed between the printed circuit board 340 and the rear surface plate 380. According to an embodiment, the antenna structure 400 may include a first slit 410 formed at a position corresponding to the first wire 501.

According to an embodiment, the electronic device 300 may further include a battery 350 and a wireless communication circuit 510, and the first wire 501 may be formed in a path that electrically connects the battery 350 and the wireless communication circuit 510.

According to an embodiment, the electronic device 300 may further include a first power management circuit 521, the printed circuit board 340 may further include a second wire 502 formed in a path configured to electrically connect the battery 350 and the first power management circuit 521, and the antenna structure 400 may further include a second slit 420 formed at a position corresponding to the second wire 502.

According to an embodiment, the electronic device 300 may further include a second power management circuit 522, the printed circuit board 340 may further include a third wire 503 formed in a path configured to electrically connect the battery 350 and the second power management circuit 522, and the antenna structure 400 may further include a third slit 430 formed at a position corresponding to the third wire 503.

According to an embodiment, the antenna structure 400 may further include a shielding member 405, and the first slit 410, the second slit 420, and the third slit 430 may be formed in the shielding member 405.

According to an embodiment, a magnetic field produced from the printed circuit board 340 may be radiated toward the rear surface plate 380 through at least one of the first slit 410, the second slit 420, and the third slit 430.

According to an embodiment, the antenna structure 400 may include at least one hole 1220 separated by at least one conductive pattern 1210 formed inside the first slit 410.

According to an embodiment, the antenna structure 400 may further include a connector 401 electrically connected to the wireless communication circuit 510.

According to an embodiment, the antenna structure 400 may further include a near field communication (NFC) antenna 441 electrically connected to the connector 401, and the NFC antenna 441 may be configured to surround the first slit 410.

According to an embodiment, the antenna structure 400 may further include at least one of a wireless charging antenna 442 and a magnetic secure transmission (MST) antenna 443 electrically connected to the connector 401.

The electronic device according to various embodiments may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include any one of, or all possible combinations of the items enumerated together in a corresponding one of the phrases. It will be understood that the terms “includes,” “comprises,” “has,” “having,” “including,” “comprising,” and the like when used in this specification, specify the presence of stated features, figures, steps, operations, components, members, or combinations thereof, but do not preclude the presence or addition of one or more other features, figures, steps, operations, components, members, or combinations thereof. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used in connection with various embodiments of the disclosure, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

The above-described embodiments are merely specific examples to describe technical content of the disclosure and help the understanding of the embodiments of the disclosure, but are not intended to limit the scope of the embodiments of the disclosure. Accordingly, the scope of various embodiments of the disclosure should be interpreted as encompassing all modifications or variations derived based on the technical spirit of various embodiments of the disclosure in addition to the embodiments disclosed herein.

What is claimed is:

1. An electronic device comprising:
a housing comprising a front surface plate, a rear surface plate, and a side surface member between the front surface plate and the rear surface plate;
a printed circuit board inside the housing, and comprising a first wire; and
an antenna structure between the printed circuit board and the rear surface plate,
wherein the antenna structure comprises a first slit at a position corresponding to a position of the first wire.

2. The electronic device of claim 1, further comprising:
a battery; and
a wireless communication circuit,
wherein the first wire is configured to electrically connect the battery and the wireless communication circuit.

3. The electronic device of claim 2, further comprising:
a first power management circuit,
wherein the printed circuit board further comprises a second wire configured to electrically connect the battery and the first power management circuit, and
wherein the antenna structure further comprises a second slit at a position corresponding to a position of the second wire.

4. The electronic device of claim 3, further comprising a second power management circuit,
wherein the printed circuit board further comprises a third wire configured to electrically connect the battery and the second power management circuit,
wherein the antenna structure further comprises a third slit at a position corresponding to a position of the third wire.

5. The electronic device of claim 4, wherein the antenna structure further comprises a shielding member, and
wherein the first slit, the second slit, and the third slit are in the shielding member.

6. The electronic device of claim 5, wherein the first slit, the second slit and the third slit of the shielding member are configured to pass a magnetic field radiated by the printed circuit board toward the rear surface plate.

7. The electronic device of claim 1, wherein the antenna structure further comprises at least one hole separated by at least one conductive pattern within the first slit.

8. The electronic device of claim 2, wherein the antenna structure further comprises a connector configured to be electrically connected to the wireless communication circuit.

9. The electronic device of claim 8, wherein the antenna structure further comprises a near field communication (NFC) antenna around the first slit and configured to be electrically connected to the connector.

10. The electronic device of claim 9, wherein the antenna structure further comprises at least one of a wireless charging antenna and a magnetic secure transmission (MST) antenna configured to be electrically connected to the connector.

11. The electronic device of claim 4, wherein the first slit, the second slit, and the third slit are integrally formed.

12. An electronic device comprising:
a housing;
a battery;
a wireless communication circuit;
at least one power management circuit;
a printed circuit board inside the housing, the printed circuit board comprising a plurality of wires configured to electrically connect the battery to the wireless communication circuit and to the at least one power management circuit, respectively; and
an antenna structure between the printed circuit board and the housing with respect to a thickness direction of the electronic device,
wherein the antenna structure comprises an opening corresponding to positions of the plurality of wires.

13. The electronic device of claim 12, wherein the antenna structure further comprises a shielding member, and
wherein the opening is in the shielding member.

14. The electronic device of claim 13, wherein a first portion of the shielding member comprises the opening, and a second portion of the shielding member comprises a portion that does not comprise the opening, and
wherein the first portion of the shielding member is configured to pass a magnetic field radiated by the printed circuit board toward the rear surface plate, and the second portion of the shielding member is configured to prevent the magnetic field radiated by the printed circuit board from radiating toward the housing.

15. The electronic device of claim 14, wherein the antenna structure further comprises a near field communication (NFC) antenna, and
wherein the NFC antenna is surrounding the opening.

16. The electronic device of claim 12, wherein the opening comprises a plurality of slits respectively corresponding to the positions of the plurality of wires.

17. The electronic device of claim 16, wherein the plurality of slits are integrally formed.
